(19) United States
(12) Patent Application Publication
(10) Pub. No.: US 2003/0122974 A1
(43) Pub. Date: Jul. 3, 2003

(54) Reflective LCD projector system

(76) Inventor: Huei-Young Ma, Hsintien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/026,788

(22) Filed: Dec. 27, 2001

(51) Int. Cl. G02F 1/1335

(52) U.S. Cl. 349/5

(57) ABSTRACT

The present invention relates to a reflective LCD projector system, including a light source, a chromatic splitting device, an image regulator, a dichroic mirror, a polarization light prism and a projecting lens. The light source is a mono polarization light beam and the chromatic splitting device converts the mono polarization light beam into the S- or the P-polarizing light beam. The polarization light prism with the image regulator and the dichoric mirror conduct image regulations on the S- and P-polarizing light beams to form an output light beam, and then project the regulated results on the projecting lens.

### BACKGROUND OF THE INVENTION

1. Field of the Invention

This invention relates to a reflective LCD projector system, in particularly, to a reflective LCD projector system for forming images on an LCD device.

2. Description of the Prior Art

Please refer to FIG. 1 of a system schematic diagram of a LCD projector of U.S. Pat. No. 5,886,754. The LCD projector includes a light source 1a, a polarization light prism 2a, a projecting lens 3a, a cross chromatic splitting lens 4a and three reflective LCD panels 5a. The polarization light prism splits the light source 1a (incandescent light) into a primary three-color light beam, which can be the P-polarization light beam or the S-polarization light beam. The cross chromatic splitting lens 4a splits the primary three-color light beam into three different color light beams and sends the three different color light beams to the three reflective LCD panels 5a respectively. Each of the reflective LCD panels 5a converts the received single color P-polarization light beam into the single color S-polarization light beam or the received single color S-polarization light beam into the single color P-polarization light beam and sends the converted single color P-polarization or S-polarization light beam to the cross chromatic splitting lens 4a. After receiving the single color S-polarization light beam or the single color P-polarization light beam, the cross chromatic splitting lens 4a combines them as an output light beam, representing an image signal parameter and projects the output light beam to the polarization light prism 2a directly. The output light beam is then reflected to the projecting lens 3a by the polarization light prism 2a.

Please refer to FIG. 2 of a schematic diagram of another prior art reflective LCD projector. This reflective LCD projector includes a light source 1a, a chromatic splitting device 6a, a color synthesizing device 7a and a projecting lens 3a. The light source 1a is a S- or P-polarization light source and the S-polarization or the P-polarization light source can be split by the chromatic splitting device 6a, which includes a first chromatic splitting lens 61a, a second chromatic splitting lens 62a, a first reflecting lens 63a, a second reflecting lens 64a, a semi wave-length panel 65a and two polarizing panels 66a and 67a. Given the input light source 1a is AsBsCs and the input light source AsBsCs is split by the first reflecting chromatic splitting lens 61a, the light As is reflected to the first reflecting lens 63a and then is converted into Ap and purified through the semi wave-length panel 65a and the polarizing panel 66a. After that, the light Ap is transmitted through the second chromatic splitting lens 62a to the color synthesizing device 7a. The light BsCs is reflected to the second chromatic splitting lens 62a by the second reflecting lens 64a and purified by the polarizing panel 67a. The second chromatic splitting lens further reflects Bs and transmits Cs to the color synthesizing device 7a.

The color synthesizing device 7a includes the first polarization light prism 71a, the second polarization light prism 72a and the third polarization light prism 73a. The lights Ap and Bs are transmitted to the first polarization light prism 71a. The light Ap is transmitted to the first reflecting LCD panel 712a by the first dielectric film 711a within the first polarization light prism 71a, converted into As, and reflected to the first dielectric film 711a. The light Bs is reflected to the second reflecting LCD panel 722a by the first dielectric film 711a, converted into Bp, and reflected to the first reflecting film 711a. The converted lights Bp and As are transmitted to the third polarization light prism 73a by the first dielectric film 711a. The light Cs is reflected to the third reflecting LCD panel 732a by the second dielectric film 721a, converted into Cp, transmitted to the second dielectric film 721a, then purified by the polarizing panel 7211a and the semi wave-length panel 7212a, reconverted into Cs, and transmitted to the third polarization light prism 73a. After receiving the lights As, Bp, and Cs, the third polarization light prism 73a generates an output light beam AsBpCs to project images on the projecting lens 3a.

However, the cross chromatic splitting lens 4a may result in inferior image qualities due to the existence of the slant gap in its interior structure, leading to the light beams will go through the cross chromatic splitting lens 4a along their extending input paths. Furthermore, the color synthesizing device 7a adopts three sets of polarization light prisms, resulting in much more costs.

### SUMMARY OF THE INVENTION

It is therefore a primary objective of the present invention to improve the output image quality and lower down the total manufacturing costs.

In accordance with the claimed invention, a reflective LCD projector system includes a light source, a color splitter for converting the input primary three-color light beam of the light source into a mixed primary three-color light beam including S and P-polarization light sources, an image regulator with the first, second and third reflective LCD panels for converting the S-polarization light source into the P-polarization light source or the P-polarization light source into the S-polarization light source, a dichroic mirror for splitting the input primary three-color light beam and the mixed primary three-color light beam, a polarization light prism for polarizing the mixed primary three-color light beam into the first primary color light, the second primary color light, and the third primary color light, and a projecting lens for projecting the output light beam.

Advantages of the present invention are to prevent the occurrences of the slant gaps and to adopt only one set of polarization light prism, and, therefore, the output quality of the present invention is superior than prior arts and the total cost of the present invention can be lowered down.

These and other objectives of the present invention will no doubt become obvious to those of ordinary skill in the art after reading the following detailed description of the preferred embodiment which is illustrated in the various figures and drawings.

### BRIEF DESCRIPTION OF THE DRAWINGS

FIG. 1 is a schematic diagram of a prior art LCD projector system.

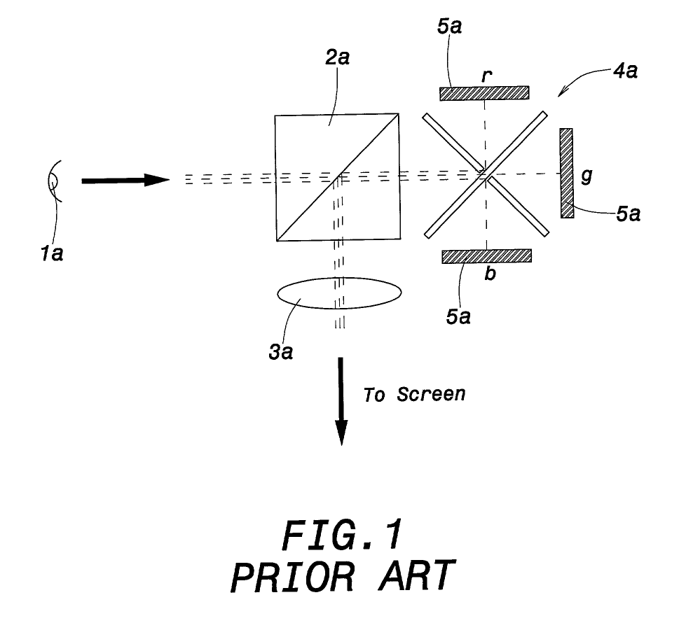

FIG. 2 is a schematic diagram of another prior art LCD projector system.

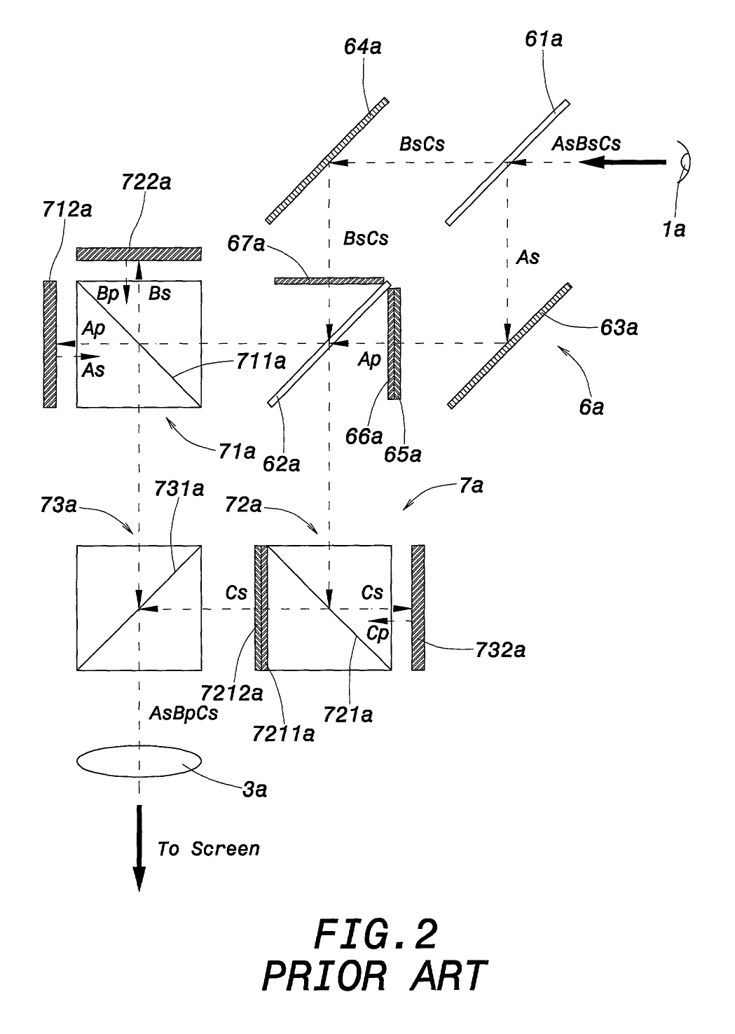

FIG. 3 is a schematic diagram of the first embodiment of the present invention.

FIG. 4 is a schematic diagram of the second embodiment of the present invention.

FIG. 5 is a schematic diagram of the third embodiment of the present invention.

FIG. 6 is a schematic diagram of the fourth embodiment according to the present invention.

### DETAILED DESCRIPTION OF THE INVENTION

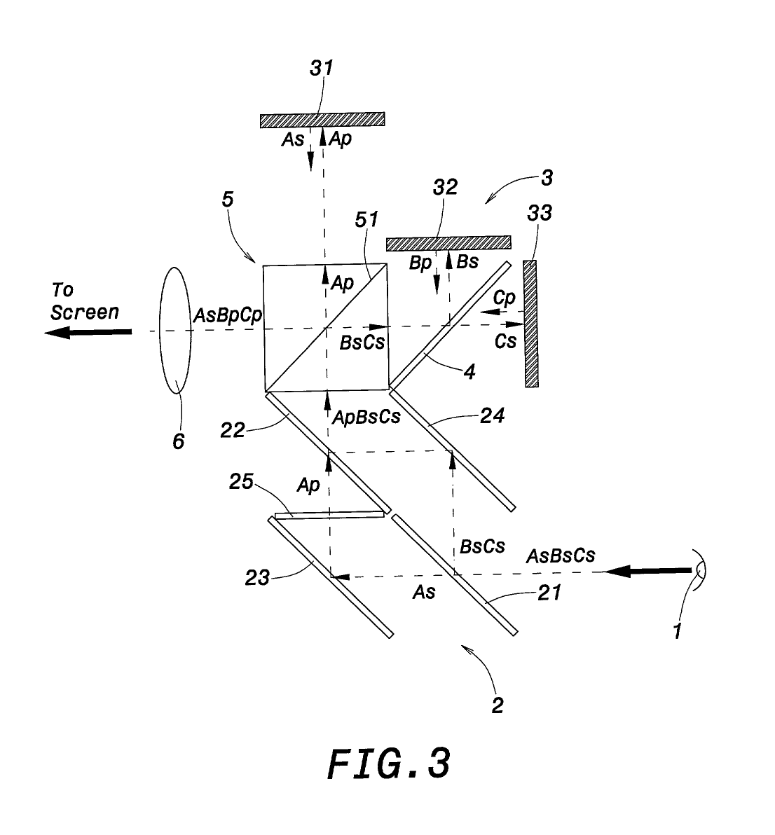

Please refer to FIG. 3 of a schematic diagram of an embodiment according to the present invention. This embodiment includes: a light source 1, a chromatic splitting device 2, an image regulator 3, a dichroic mirror 4, a polarization light prism 5 and a projecting lens 6. The light source 1 is a mono polarization light source of parallel incidence, and, in this embodiment, the mono polarization light source refers to the input light source of AsBsCs with three primary colors. The light source can be the S-polarization light source or the P-polarization light source, and, the three primary colors are red, green and blue.

The chromatic splitter device 2 is to convert the input light source, the mono polarization light beam with three primary colors, into a mixed primary three-color light beam, which may include the S polarization light or the P polarization light. The chromatic splitter device 2 includes a first dichroic mirror 21, a second dichroic mirror 22, a first reflecting lens 23, a second reflecting lens 24 and a semi wavelength panel 25. The first dichroic mirror 21 is to transmit the first primary color light beam As to the first reflecting lens 23, and reflect the other two-color primary light beam BsCs to the second reflecting lens 24. After that, the first reflecting lens 23 reflects As to the semi wavelength panel 25, which converts the S polarization light beam As to form the P polarization light beam Ap and to transmit the light beam Ap to the second dichroic mirror 22. The second reflecting lens 24 is to reflect other primary two-color light beam BsCs to the second dichroic mirror 22. At last, the light beam Ap is through the second dichroic mirror 22 directly and the primary two-color light beam BsCs is reflected by the second dichroic mirror 22, as this result, an output light beam with primary three-color ApBsCs is outputted.

The image regulator 3 includes a first reflective LCD panel 31, a second reflective LCD panel 32 and a third reflective LCD panel 33. The image regulator is to convert the S-polarization light beam into P-polarization one or vice versa. The dichroic mirror 4 is used to split the input primary three-color light beam and the mixed primary three-color light beam.

The polarization light prism 5 is used to polarize the primary three-color light beam ApBsCs into a first, second, and third primary color light beam, to transmit the P-polarization light beam, and to reflect the S-polarization light beam by the dielectric film 51 within the polarization light prism 5. Furthermore, the first primary color light beam Ap is transmitted to the first reflective LCD panel 31, the second primary color light beam Bs is reflected to the second reflective LCD panel 32 through the dichroic mirror 4, and the third primary color light beam Cs is transmitted to the third reflective LCD panel 33 through the dichroic mirror 4. Then the image regulator 3 regulates the first, the second, and the third primary color light beam from the S polarization type to the P polarization type or vice versa, and reflects the polarized primary color light beam along their original input routes to form an output light beam AsBpCp. Finally, the projecting lens projects the output light beam AsBpCp onto the display.

According to the above embodiment, this present invention is capable of dealing with the problem of slant gap, leading to that images can be outputted to the projecting lens 6 in a high fidelity and solving the known defect of dark lines shown in output images. Additionally, in comparison with prior arts, only one set of polarization light prism is used in this present invention, lowering down the total manufacturing costs.

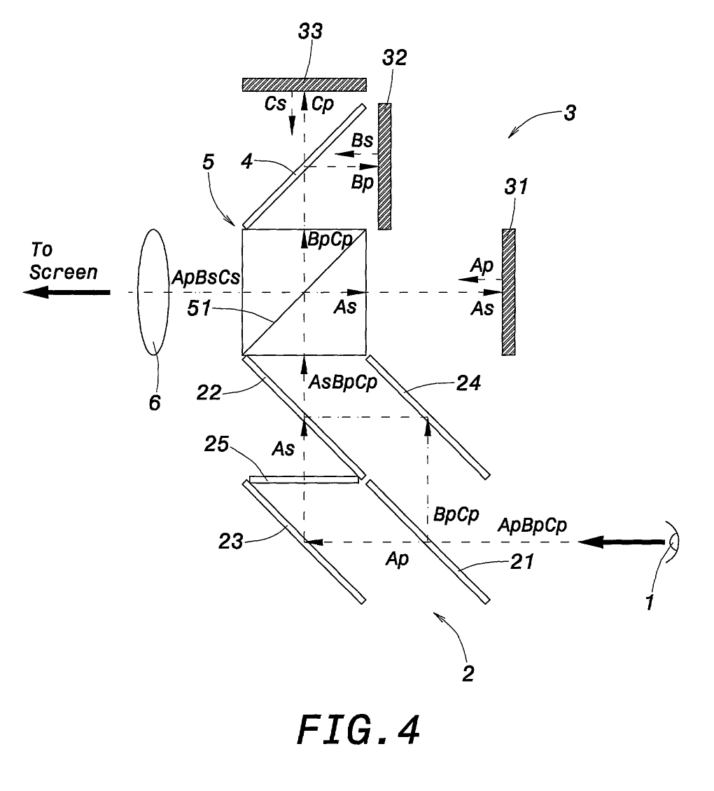

Please refer to FIG. 4 of a schematic diagram of another embodiment of the present invention. The setting of the first reflective panel 31, the second reflective panel 32, and the third reflective panel 33 has been changed in this embodiment corresponding with the situation that the primary three-color input light beam is ApBpCp and the mixed primary three-color light beam is AsBpCp.

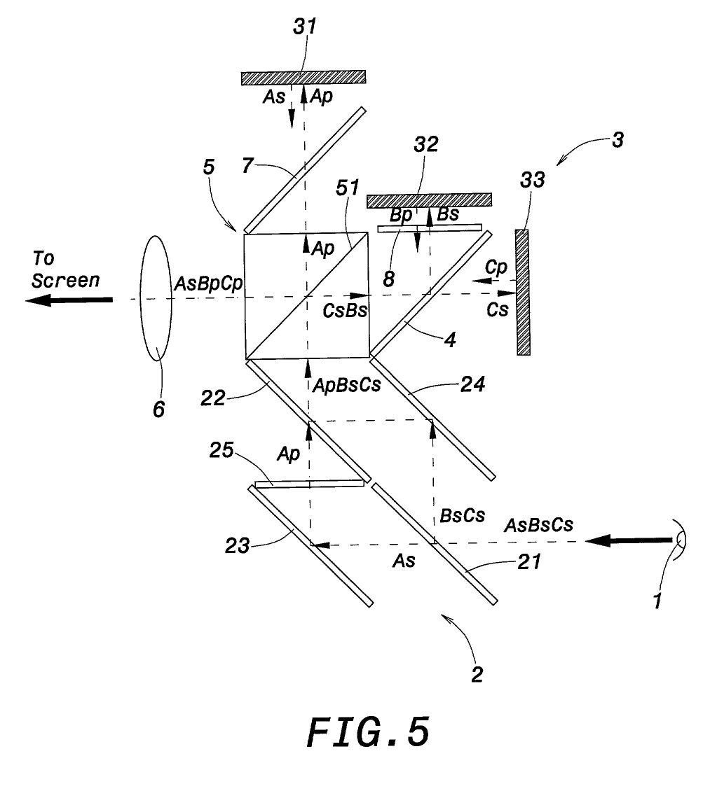

Please refer to FIG. 5 of a schematic diagram of another embodiment of the present invention. A light filter 8 is further set between the first reflective LCD panel 31 and the polarization light prism 5, and another light filter 8 is set between the second reflective LCD panel 32 and the dichroic mirror 4. The aforementioned setting is used to purify light beams between the projecting lens 6 and the image regulator 3 and to make optical routes of the projecting lens 6 between three reflective LCD panels 31, 32, and 33 be the same.

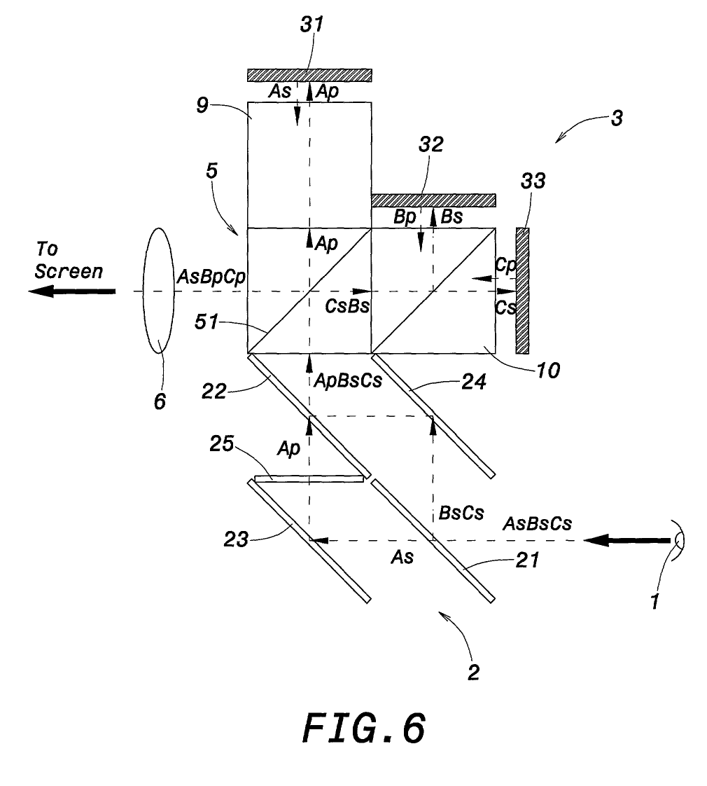

Please refer to FIG. 6 of a schematic diagram of another embodiment of the present invention. A transparent block 9 is further set between the first reflective LCD panel 31 and the polarization light prism 5, and the original dichroic mirror 4 is replaced with a color splitting prism 10. The refraction ratio of the transparent block 9 is large than 1, lowering down optical routes of the projecting lens 6 between three reflective LCD panels 31, 32, and 33 also by the setting of the transparent block 9 and the color splitting prism 10.

Therefore, the reflective LCD projector system of this invention is with following characteristics in comparison with prior arts:

(1) superior output quality images; and

(2) less manufacturing costs;

The above embodiments presented to demonstrate this invention shall not limit its patent range, as all structural modifications based on the manual and drawings of this invention shall be included in the invention.

1. A reflective LCD projector system comprising:
a light source for providing a mono polarization light source;
a chromatic splitting device for converting an input primary three-color light beam of the mono polarization light source into a mixed primary three-color light beam including S and P-polarization light sources;
an image regulator, including a first, a second and a third reflective LCD panels for converting the S-polarization light source into the P-polarization light source or the P-polarization light source into the S-polarization light source;
a dichroic mirror for splitting different primary color light beams;
a polarization light prism for polarizing the mixed primary three-color light beams into a first primary color light beam, a second primary color light beam, and a third primary color light beam, the first primary color light beam being reflected to the first reflective LCD panel by the dichroic mirror, the second primary color light beam being reflected to the second reflective LCD panel by the dichroic mirror, the third primary color light beam being reflected to the third reflective LCD panel by the dichroic mirror respectively, and the image regulator separately regulating and reflecting the first primary color light beam, the second primary color light beam, and the third primary color light beam, and the regulated first primary color light beam, the regulated second primary color light beam and the regulated third primary color light beam being reflected back through their corresponding optical routes for generating an output light beam; and
a projecting lens for projecting the output light beam.

2. The reflective LCD projector system of claim 1, wherein the mono polarization light source is a S-polarization light beam or a P-polarization light beam.

3. The reflective LCD projector system of claim 1 wherein the input primary three-color light beam comprises red, green, and blue colors.

4. The reflective LCD projector system of claim 1 wherein the dichroic mirror is a light prism.

5. The reflective LCD projector system of claim 1 further comprising a light filter disposed between the first reflective LCD panel and the polarization light prism.

6. The reflective LCD projector system of claim 1 further comprising a transparent block disposed between the first reflective LCD panel and the polarization light prism.

7. The reflective LCD projector system of claim 1 further comprising a light filter being disposed between the second reflective LCD panel and the dichroic mirror.
